(19) United States
(12) Patent Application Publication
(10) Pub. No.: US 2012/0254851 A1
(43) Pub. Date: Oct. 4, 2012

(54) Energy Efficiency Control Policy Library

(75) Inventor: Wael William Diab, San Francisco, CA (US)

(73) Assignee: Broadcom Corporation, Irvine, CA (US)

(21) Appl. No.: 13/077,461

(22) Filed: Mar. 31, 2011

(51) Int. Cl. G06F 9/445; G06F 9/44

(52) U.S. Cl. 717/171; 717/176

(57) ABSTRACT

An energy efficiency control policy library. Network devices can access the energy efficiency control policy library to download library control policies that are compatible with the network device. Such library control policies can be identified based on configuration information that is provided to the energy efficiency control policy library. In this control policy provider framework, the energy efficiency control policy library can be designed to monitor and analyze configuration and performance information that is uploaded from the network devices. Such continual monitoring and analysis would enable the energy efficiency control policy library to identify continual optimizations to the control policy in the network device.

### BACKGROUND

1. Field of the Invention

The present invention relates generally to energy efficient Ethernet networks and, more particularly, to an energy efficiency control policy library.

2. Introduction

Energy costs continue to escalate in a trend that has accelerated in recent years. Such being the case, various industries have become increasingly sensitive to the impact of those rising costs. One area that has drawn increasing scrutiny is the IT infrastructure. Many companies are now looking at their IT systems' power usage to determine whether the energy costs can be reduced. For this reason, an industry focus on energy efficient networks has arisen to address the rising costs of IT equipment usage as a whole (i.e., PCs, displays, printers, servers, network equipment, etc.).

In designing an energy efficient solution, one of the considerations is the utilization of the network link. For example, many network links are typically in an idle state between sporadic bursts of data, while in other network links, there can be regular or intermittent low-bandwidth traffic, with bursts of high-bandwidth traffic.

Conventionally, an energy efficiency control policy in a network device can analyze the link utilization to determine whether to adapt the link, link rate, and layers above the link (e.g., layer 2 or higher) to an optimal solution based on various energy costs and impact on traffic. Due to the limited processing capabilities in the network device, this level of analysis can often provide only a coarse mechanism for intelligently saving energy. It often falls short of the ideal.

This is especially true due to the numerous considerations that can influence the optimization of a particular energy efficiency control policy to a specific network device, application requirements, traffic conditions, energy efficiency capabilities in the network device, etc. What is needed therefore is a mechanism that improves the ability to customize an energy efficiency control policy to thereby tailor an energy saving solution to the particular performance characteristics of a given network device installation.

### SUMMARY

An energy efficiency control policy library, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an Ethernet link between a local and remote link partner.

FIG. 2 illustrates an embodiment of a control policy library system.

FIG. 3 illustrates a flowchart of a first process of the present invention.

FIG. 4 illustrates a flowchart of a second process of the present invention.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Energy Efficient Ethernet networks attempt to save power when the traffic utilization of the network is not at its maximum capacity. This serves to minimize the performance impact while maximizing energy savings. At a broad level, the energy efficiency control policy for a particular link in the network determines when to enter an energy saving state, what energy saving state (i.e., level of energy savings) to enter, how long to remain in that energy saving state, what energy saving state to transition to out of the previous energy saving state, etc. In one embodiment, energy efficiency control policies can base these energy-saving decisions on a combination of settings established by an IT manager and the properties of the traffic on the link itself.

In the present invention, it is recognized that the initial establishment of an energy efficiency control policy for a particular network device represents a best “guess” at identifying an energy efficiency control policy that satisfies broader energy-savings initiatives. The actual performance of such an initial energy efficiency control policy may or may not achieve those energy-savings initiatives. More significantly, the initial energy efficiency control policy is unlikely to achieve an optimal level of performance relative to a given set of performance metrics.

Further complicating the process is the continual evolution of energy efficiency capable devices. Each new generation of devices can include different sets of energy efficiency capabilities that can be leveraged differently in particular application, traffic, and performance-objective environments.

Ideally, energy efficiency control policies are continually adapted or customized to address the dynamics of a particular network device installation. Due to the limited processing capabilities of network devices, self-adaptation or self-customization of an energy efficiency control policy by a network device itself has limited potential in identifying a truly optimal energy-savings solution. This is not surprising in that a network device is designed primarily for traffic processing and routing. The energy-savings functionality in the network device is a secondary function that attempts to extract energy savings data and perform analysis where possible. As the network device is not primarily focused on energy savings, the sub-optimal results achieved are not surprising.

In the present invention, energy savings are increased through a mechanism that enables a focused analysis on the energy-savings initiatives effected by hardware logic in the network device. Here, it is a feature of the present invention that the achievable energy savings in a network device is not limited by the processing capabilities of the network device. As will be described in greater detail below, an energy efficiency control policy library is provided that offers control policy services to a plurality of network devices. In one embodiment, the energy efficiency control policy library can be designed to identify a particular energy efficiency control policy that can be downloaded to a particular network device. This particular energy efficiency control policy can be identified based on an analysis of a configuration and capabilities (e.g., profile information) of the network device as well as performance metrics that are provided to the energy efficiency control policy library by the network device. As the energy efficiency control policy library can have relatively unlimited processing resources dedicated to energy efficiency control policy customizations, the energy efficiency control policy generated for a given network device is free from network device limitations that hinder optimization.

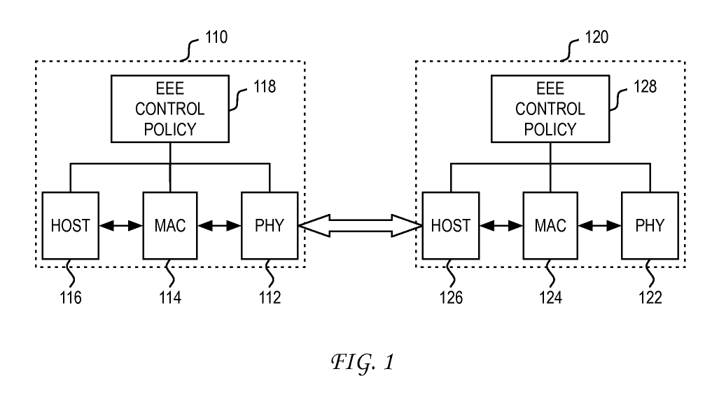

Prior to describing the present invention in greater detail, reference is first made to FIG. 1, which illustrates an example link to which an energy efficiency control policy can be applied. As illustrated, the link supports communication between a first link partner 110 and a second link partner 120. In various embodiments, link partners 110 and 120 can represent a switch, router, endpoint (e.g., server, client, VOIP phone, wireless access point, etc.), or the like. As would be appreciated, the link can operate at standard or non-standard (e.g., 2.5G, 5G, 10G, 40G, etc.) link rates, as well as future link rates (e.g., 100G, 400G, 1T, etc.). The link can also be supported by various port types (e.g., backplane, twisted pair, optical, etc.) and in various applications (e.g., Broadreach Ethernet, EPON, etc.). As illustrated, link partner 110 includes physical layer device (PHY) 112, media access control (MAC) 114, and host 116, while link partner 120 includes PHY 122, MAC 124, and host 126.

In general, hosts 116 and 126 may comprise suitable logic, circuitry, and/or code that may enable operability and/or functionality of the five highest functional layers for data packets that are to be transmitted over the link. Since each layer in the OSI model provides a service to the immediately higher interfacing layer, MAC controllers 114 and 124 may provide the necessary services to hosts 116 and 126 to ensure that packets are suitably formatted and communicated to PHYs 112 and 122, respectively. MAC controllers 114 and 124 may comprise suitable logic, circuitry, and/or code that may enable handling of data link layer (Layer 2) operability and/or functionality. MAC controllers 114 and 124 can be configured to implement Ethernet protocols, such as those based on the IEEE 802.3 standard, for example. PHYs 112 and 122 can be configured to handle physical layer requirements, which include, but are not limited to, packetization, data transfer and serialization/deserialization (SERDES).

During transmission, each layer may add its own header to the data passed on from the interfacing layer above it. During reception, a compatible device having a similar OSI stack may strip off the headers as the message passes from the lower layers up to the higher layers.

In general, controlling the data rate of the link may enable link partners 110 and 120 to communicate in a more energy efficient manner. More specifically, a reduction in link rate to a sub-rate of the main rate enables a reduction in power, thereby leading to energy savings. In one example, this sub-rate can be a zero rate, which produces maximum power savings. Examples of different forms of subrating in a PHY include subset PHY techniques and low power idle (LPI) techniques. In general, both the subset and LPI techniques involve turning off or otherwise modifying portions of the PHY during a period of low link utilization. As in the PHY, power savings in the higher layers (e.g., MAC) can also be achieved by using various forms of subrating as well.

As FIG. 1 further illustrates, link partners 110 and 120 also include energy efficiency control policy entities 118 and 128, respectively. In general, energy efficiency control policy entities 118 and 128 can be designed to determine when to enter an energy saving state, what energy saving state (i.e., level of energy savings) to enter, how long to remain in that energy saving state, what energy saving state to transition to out of the previous energy saving state, etc. Energy efficiency control policy entities can also effect a change in a traffic profile. For example, an energy efficiency control policy entity can buffer normal data traffic longer before waking up a link. This would be in contrast to voice over IP (VOIP) traffic and/or Ethernet audio video bridging (AVB) traffic, which is very latency sensitive, and would need to be transmitted immediately.

In general, energy efficiency control policy entities 118 and 128 can comprise suitable logic, circuitry, and/or code that may be enabled to establish and/or implement an energy efficiency control policy for the network device. In various embodiments, energy efficiency control policy entities 118 and 128 can be a logical and/or functional block which may, for example, be implemented in one or more layers, including portions of the PHY or enhanced PHY, MAC, switch, controller, or other subsystems in the host, thereby enabling energy-efficiency control at one or more layers.

A computing environment such as a medium or large enterprise environment can include a large number of such network devices that can be arranged in particular topologies. For example, such an environment can include hundreds and even thousands of network switches that are designed to interconnect large numbers of computing devices. In supporting a variety of application services, the collection of network devices can place unique demands on efforts that identify potential energy savings. Administrating individual energy efficiency control policies or a global control policy for this collection of network devices can be challenging due to the mix of devices and application services provided.

In the present invention, the primary responsibility for management of energy efficiency control policies is a control policy library system. Such a control policy library system is generally designed to provide control policy services to a plurality of network devices, thereby obviating the need for the network devices to manage their own energy efficiency control policies.

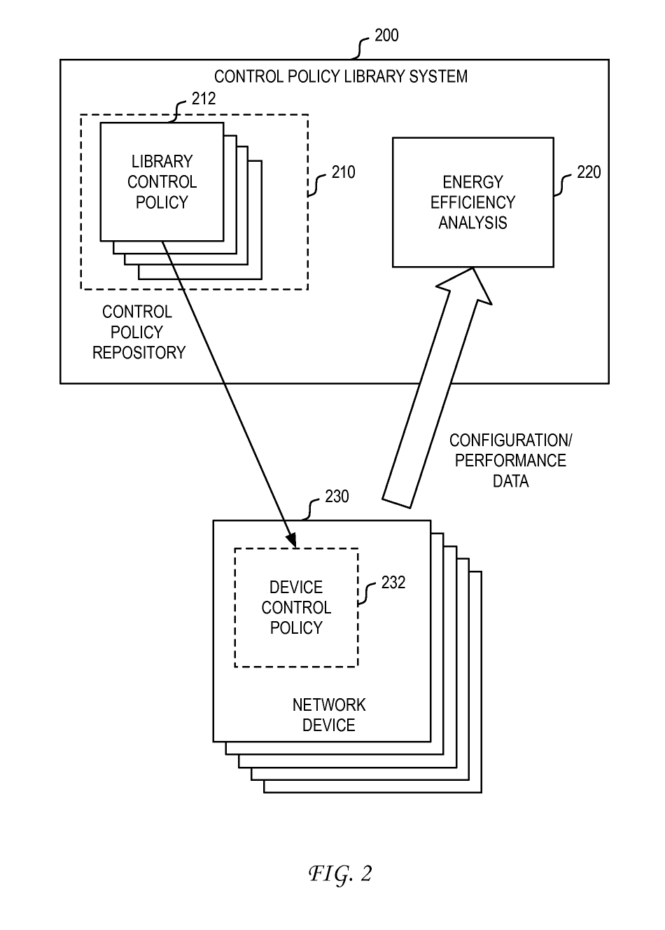

FIG. 2 illustrates a high-level overview of a framework for implementing a control policy library system. As illustrated, the framework includes control policy library system 200 that interacts with a plurality of network devices. As would be appreciated, control policy library system 200 need not be physically co-located or on the same physical network or intra-net as the plurality of network devices. As such, control policy library system 200 can be on the same network or on another network controlled by a different entity.

In this illustration, details of a single network device 230 is shown for simplicity. Control policy library system includes control policy repository 210, which includes a plurality of library control policies. For simplicity only one of the library control policies identified in the control policy repository is identified as library control policy 212.

Control policy library system also includes energy efficiency analysis module 220. In general, energy efficiency analysis module 220 is designed to assist in an identification of one of a plurality of library control policies contained in control policy repository 210 that is to be sent to a particular network device. As illustrated, library control policy 212 is transmitted from control policy library system 200 to network device 230, which installs a downloaded library control policy 212 as device control policy 232. In one embodiment, device control policy 232 is an energy efficiency control policy software module that is installed in network device 230. The installation of the energy efficiency control policy software module is designed to enable control of hardware logic in the network device that implements an energy efficiency control policy in the network device.

More generally, the control policy library system 200 framework described above can be applied at a system level in a similar manner as described above in its application to a particular network device. Here, assume that a network system includes a set of switches, routers and/or end devices, wherein the network system is governed by a global control policy. In this scenario, control policy library system can include a plurality of library global control policies that can be configured for use as a network global control policy for the network system.

In one embodiment, control policy repository 210 in control policy library system enables a type of control policy marketplace where end-customers can purchase a library control policy for use as a device control policy in their network device. In this software module service framework, the end-customer can select from a variety of library control policies that are available for download for use in the network device. As would be appreciated, the different types of available library control policies can be targeted to a particular hardware configuration (e.g., manufacturer model number), application service(s) supported, network topology, energy savings goals (e.g., level of aggressiveness to achieve energy savings), etc.

Identification of library control policies that are available for a network device can be performed by energy efficiency analysis module 220. In a simple example, energy efficiency analysis module 220 can be designed to perform a simple table look up to identify particular library control policies that are usable by a particular manufacturer model number. In another example, the energy efficiency analysis module 220 can be designed to identify particular library control policies that can be used by network devices that support particular application services that have been identified. In yet another example, energy efficiency analysis module 220 can be designed to identify library control policies based on configuration and performance data generated. Here, the performance data can represent traffic information, energy efficiency statistics, or other usage data that can enable energy efficiency analysis module 220 to determine a library control policy that is usable by a network device. This performance data need not be energy-efficiency specific. Rather, the performance data can represent any data that would be useful in an energy-efficiency analysis.

More generally, energy efficiency analysis module 220 can be used to support a service model in which network devices periodically upload configuration and performance data to the control policy library system 200 for analysis. In this framework, energy efficiency data processing and analysis is offloaded from network devices to control policy library system 200, which can have dedicated computing resources that are designed to analyze the configuration and performance data to determine whether any updates to a device control policy or a change in settings of the device control policy are needed. In various embodiments, energy efficiency analysis module 220 can be implemented as independent hardware (i.e., stand alone system), part of the hardware in control policy library system 200, software and/or combinations of the above and/or combinations with other systems in the network.

Based on an analysis of configuration and performance data, control policy library system 200 can be designed to provide a report that can include energy savings data for network devices it is monitoring. In one example, a report can identify for a customer an amount of energy saved, a measure of energy efficiency for a particular period (e.g., time of day), particular application, etc. In another example, a report can provide recommendations to an IT manager regarding one or more network devices that should be turned off, one or more network devices that should be brought online, optimizations to a particular topology to enable higher efficiency for a given work load, etc.

To illustrate the operation of control policy library system 200, several examples of the identification of a library control policy are provided. In a first example, consider a network device that has a configuration interface (e.g., Websmart functionality) that enables a form of remote management. This lightly-managed network device can be designed to access control policy library system to download one of the plurality of library control policies that are stored in the control policy repository. In one embodiment, the network device can forward configuration information that enables the control policy library system to identify one or more library control policies that are suitable for the network device. The selected library control policy can then be downloaded and installed as the device control policy in the network device.

By this process, the network device can be configured for energy efficiency functionality remotely through access to the control policy library system. One benefit of this form of control-policy configuration is the installation of the latest or most current energy efficiency control policy software module that can leverage the hardware logic installed in the network device. Another benefit of this form of control-policy configuration is that the end-customer can customize the control policy to a particular application for which the network device is being configured to support. This targeted functionality of the control policy would not be possible by the manufacturer, which would likely pre-install a general purpose control policy to meet the varied potential uses of the network device by various end-customers.

Another example application of the control policy library system is the support of an original equipment manufacturer (OEM). Consider for example an OEM that received a purchase order from a particular customer. In this scenario, the OEM can meet the specific needs of the customer by accessing the control policy library system and downloading the particular library control policies that would meet the customer's needs. For example, should the customer have different uses for different network switches, the OEM can download different control policies to meet those intended uses.

As noted above, the energy efficiency control policy is unlikely to represent the primary functionality of the network device. Through the access of a dedicated control policy library system, the OEM can leverage the expertise of the operator of the control policy library system in producing products that meet the customer's needs. As an illustration of such a benefit, the OEM can also ship a product without an installed energy efficiency control policy and provide the customer with the means to perform their own customizations in downloading a specific library control policy from the control policy library system. As would be appreciated, the customer can select a particular library control policy based on an application, application requirements, and/or traffic profile in addition to the hardware configuration of the network device. As in the above example, the control policy library system gives the customer maximum flexibility of configuration of the energy-efficiency features of a network device.

As the above examples illustrate, the control policy library system can be used to support custom installations of library control policies onto network devices. A further benefit of the control policy library system is the monitoring and updating of installed device control policies. This can be a dynamic process. In one example, consider a network device in a specific location that deals with different applications/traffic over time. This can change day-to-day or hour-to-hour and can also interact with the network demands the application or IT manager sets (including power restrictions and performance restrictions). In another example, the network device itself can be moved from one location in the network to another location in the network where the type of traffic is different. For instance, in a data center, the network device can change from dealing with web applications to intranet traffic. In another instance, the network device can be moved from one wiring closet in one building that supports CAD engineers to another wiring closet in another building that supports marketing.

Typically, an initial installation of a energy efficiency control policy software module represents the best understanding of an energy efficiency control policy that can satisfy particular energy-savings objectives. Unfortunately, the actual performance of the energy efficiency control policy may not meet those objectives.

To address this scenario, a network device with an installed device control policy can be designed to periodically upload configuration and performance data to control policy library system. As the control policy library system is dedicated to energy efficiency control policy services, the control policy library system can incorporate dedicated processing functionality in an energy efficiency analysis module that can analyze the operation of installed device control policies in a plurality of network devices in generating energy savings. For a specific network device, the monitoring provided by the energy efficiency analysis module can be used to identify any potential updates or reconfiguration needed to an installed device control policy. For example, if an update to a device control policy is needed, then control policy library system can download a new library control policy to the network device to replace the previously-installed device control policy. Further monitoring of performance and configuration information can then determine whether energy efficiency has improved in the network device. This example illustrates the importance of having a mechanism that can continually customize an energy efficiency control policy for a network device.

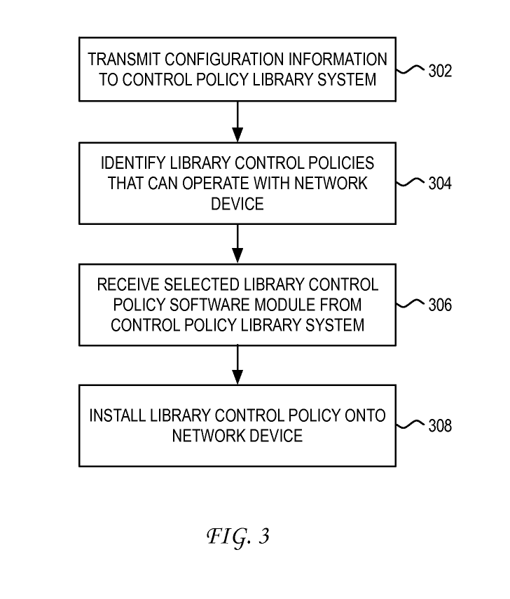

To further illustrates the principles of the present invention, reference is now made to the flowchart of FIG. 3, which illustrates an installation process using a control policy library system. As illustrated, the process begins at step 302 where a network device transmits configuration information to a control policy library system. In one example, the configuration information includes information that enables the control policy library system to identify energy efficiency capabilities of the network device. These energy efficiency capabilities can be determined in various ways such as a manufacturer model number, software/hardware version number, or the like. In another example, the configuration information can include information that identifies the application, application requirements, traffic profiles, or other information that enables the control policy library system to determine how the network device is to be used. In yet another example, the configuration information can include information (e.g., topology information, link partner information, etc.) that identifies an environment in which the network device will operate. As would be appreciated, the specific type or form of configuration information that is sent to the control policy library system would be implementation dependent. More generally, network device profile information reflective of configuration, capabilities, and operation of the network device can be uploaded to the control policy library system for consideration.

At step 304, the control policy library system can use the configuration information to identify one or more library control policies that can operate with the network device. In one example, the identified library control policies are designed for use with particular energy efficiency capabilities (e.g., LPI functionality) that have been included in the network device. These energy efficiency capabilities may have been included in the network device originally, or may have been included in the network device upon an upgrade of the hardware/software/firmware in the network device. In another example, the identified library control policies are targeted for use with particular applications for which the network device is designed to support. In yet another example, the identified library control policies are targeted for use in a particular segment of a network topology.

The identification of one or more control policies that can be installed in the network device represents a type of energy-efficiency customization of the network device. This energy-efficiency customization is a key factor in maximizing the potential energy savings that can be achieved by a particular type of network device operating with a particular application or application requirements in a particular segment of a network. Absent such customization, the network device's energy efficiency capabilities would be limited to generic functionality that is intended for general-purpose use.

Having identified one or more library control policies that can be used in the network device, a selection of a particular library control policy for use in the network device can then commence. In various scenarios, the entity that selects the library control policy for installation can be an end-customer, an OEM, an IT manager, or the like, who is designated to customize the energy-efficiency functionality in the network device. Regardless of the party who is designated for customization, the control policy library system can enable a service model that delivers fee-based control policy services.

At step 306, the network device then receives a library control policy software module for installation in the network device. In one embodiment, the library control policy software module has been pre-configured for download. In another embodiment, the library control policy software module represents a customization or other configuration of a base library control policy software module using the configuration information provided by the network device. In yet another embodiment, the library control policy software module can be designed to enable hardware. For example, the library control policy software module can be designed to unlock a feature (e.g., hardware module, memory, etc.) on the network device until payment for service has been received. Unlocking of such a feature would thereby enable increased energy efficiency analysis, capabilities, etc.

Wither pre-configured or post-configured, the library control policy software module downloaded to the network device is designed to be installed onto the network device at step 308. Here, it should be noted that the library control policy software module represents a block of code that has been architected for installation as a module (e.g., plug-in) that is part of or interacting with an operating system run by the network device. While the particular energy-efficiency functionality would be implementation dependent, the library control policy software module is designed for energy efficiency control through communication with a power management unit in the network device as well as interfaces to the host and various subsystems. As such, the library control policy software module can be designed to effect control functions that can change a speed of a processor, speed of a bus, clock rate, transmission rate, subsystem powering, etc.

It is a feature of the present invention that the control policy library system can enable control policy additions, control policy changes, and control policy updates through a remote control policy provider. Control policy additions, for example, can be implemented based on the need for additional quality of service capabilities in the network device.

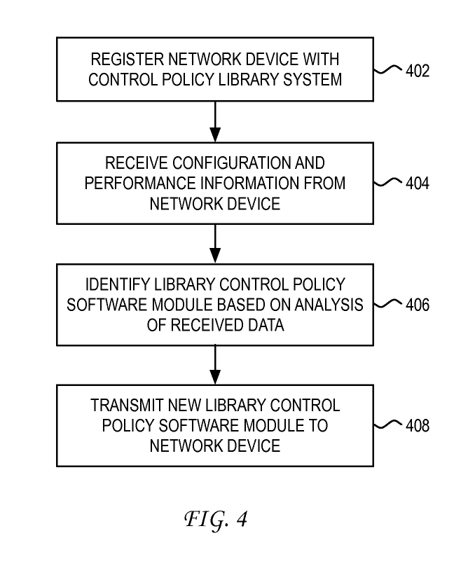

The necessity of changes or updates to a device control policy highlights a significant benefit of a control policy provider model. FIG. 4 illustrates a flowchart of a process that enables changes or updates of control policies contained with network devices.

As illustrated, the process begins at step 402, where the control policy library system registers a network device. In one example of this registration process, the control policy library system can store network device configuration information and device control policy information in a network device database that can be accessed using identification information (e.g., MAC address) of the network device. The network device database provides a structured mechanism by which energy efficiency analysis module 220 can analyze the relative energy-efficiency performance of the registered network devices.

In one embodiment, registration of a network device with the control policy library system would include a download of a software application (e.g., applet) that can be designed to track one or more parameters (e.g., buffer information) or statistics (e.g., link utilization, energy savings) that reflect on the energy-efficiency performance of an installed device control policy. The particular set of parameters or statistics that are monitored would be implementation dependent.

At step 404, the control policy library system would receive configuration and performance information from the registered network devices. In the example where a software application has been installed on the network device for monitoring purposes, the software application can be designed to upload monitoring data in a manner similar to diagnostic trace information. Such diagnostic energy-efficiency trace information would enable the control policy library system to analyze in a detailed manner the performance of the device control policy. As an example, a traffic analysis can be based on correlations with a time of day, applications present, type of traffic, etc. As would be appreciated, the energy-efficiency trace information can be uploaded periodically to the control policy library system. While an upload of energy-efficiency trace information can enable an immediate analysis, a periodic upload of energy-efficiency trace information can enable an historical analysis based on a longer timeframe. In various embodiments, the configuration and performance information can be uploaded to or via a manager, server, outside network, virtual machine, etc.

Here, it should be noted that the detailed analysis of trace-like information generated by the network device would not be possible in the network device itself as the network device does not have dedicated processing facilities such as that contained in the control policy library system.

Based on the analysis of the configuration and performance information, the control policy library system can then identify a new library control policy for the network device at step 406. This new library control policy can represent an incremental change or update to an existing device control policy in the network device to facilitate improved energy-efficiency performance.

At step 408, the new library control policy software module is then downloaded to the network device for installation. As noted above, the library control policy software module can be pre-configured or can be a customization or other configuration of a base library control policy software module.

The downloading of a changed or updated control policy software module represents a part of a service-based optimization process of energy-efficiency efforts in the network device. Conventional changes or updates to control policies have been based on limited information and have largely confined to a generic control policy that was installed by the original manufacturer. In the present invention, a control policy provider model enables continued optimization of control policies in a structured manner using highly-granular monitoring information.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. An energy efficient Ethernet method, comprising:
transmitting, from a network device to an energy efficiency control policy library system, information that enables said energy efficiency control policy library system to identify energy efficiency capabilities of said network device;
receiving, from said energy efficiency control policy library system, information regarding a plurality of library energy efficiency control policies that can operate with said energy efficiency capabilities of said network device;
transmitting, to said energy efficiency control policy library system, a selection of one of said plurality of energy efficiency control policies; and
receiving, from said energy efficiency control policy library system, an energy efficiency control policy software module corresponding to said selected energy efficiency control policy; and
installing said energy efficiency control policy software module in said network device, wherein said installed energy efficiency control policy software module enables control of hardware logic that implements an energy efficiency control policy in said network device.

2. The method of claim 1, wherein said transmitting information that enables said energy efficiency control policy library system to identify energy efficiency control policy capabilities of said network device comprises transmitting hardware or software version information.

3. The method of claim 1, wherein said transmitting information that enables said energy efficiency control policy library system to identify energy efficiency control policy capabilities of said network device comprises transmitting model number information.

4. The method of claim 1, wherein said transmitting information that enables said energy efficiency control policy library system to identify energy efficiency control policy capabilities of said network device comprises transmitting energy efficient Ethernet configuration information.

5. The method of claim 1, wherein said transmitting information that enables said energy efficiency control policy library system to identify energy efficiency control policy capabilities of said network device comprises transmitting information to a virtual machine.

6. The method of claim 1, wherein said installing comprises installing an energy efficiency control policy in said network device for a first time, wherein prior to said installation, said network device did not have a prior energy efficiency control policy software module installed.

7. The method of claim 1, wherein said installing comprises replacing an energy efficiency control policy software module that was previously installed in said network device.

8. An energy efficient Ethernet method in an energy efficiency control policy library system, comprising the following computer implemented steps:
registering a network device in said energy efficiency control policy library system, said registration assigning said energy efficiency control policy library system as a fee-based provider of energy efficiency configuration services for said network device, said energy efficiency control policy library system storing a plurality of energy efficiency control policy software modules that are selectable for use by a plurality of registered network devices;
periodically receiving, from said network device, configuration and performance information for said network device, said receipt of said periodic configuration and performance information enabling said energy efficiency control policy library system to identify a first level of energy efficiency of said network device;
selecting one of said plurality of energy efficiency control policy software modules based on an analysis of said received configuration and performance information;
configuring said selected one of said plurality of energy efficiency control policy software modules for use in said network device; and
transmitting said configured energy efficiency control policy software module to said network device, wherein an installation of said configured energy efficiency control policy software module on said network device enables control of hardware logic that implements an energy efficiency control policy in said network device.

9. The method of claim 8, wherein said receiving comprises receiving information that enables an identification of a hardware configuration of said network device.

10. The method of claim 8, wherein said receiving comprises receiving traffic information.

11. The method of claim 8, wherein said receiving comprises receiving performance information.

12. The method of claim 8, wherein said configured energy efficiency control policy software module is a first energy efficiency control policy software module to be installed on said network device.

13. The method of claim 8, wherein said configured energy efficiency control policy software module replaces a energy efficiency control policy software module that was previously installed on said network device.

14. The method of claim 8, wherein said configuring comprises configuring a module that can be installed as a unit.

15. An energy efficient Ethernet method in an energy efficiency control policy library system, comprising the following computer implemented steps:
registering a plurality of network devices in said energy efficiency control policy library system, said registration assigning said energy efficiency control policy library system as a fee-based provider of energy efficiency configuration services for said plurality of network devices;
storing, in said energy efficiency control policy library system, configuration and performance information that is periodically received from said plurality of network devices, wherein said registration of said plurality of network devices shifts a responsibility of analyzing said configuration and performance information from said plurality of network devices to said energy efficiency control policy library system;
based on said analyzing, configuring an energy efficiency control policy software module for each of said plurality of network devices; and
transmitting said plurality of energy efficiency control policy software modules individually to said plurality of network devices, wherein a configured energy efficiency control policy software module is designed for replacement of an existing energy efficiency control policy software module that was previously installed on a network device.

16. The method of claim 15, wherein said registered plurality of network devices do not analyze said configuration and performance information at said plurality of network devices to determine an adjustment of an energy efficiency control policy.

17. The method of claim 15, wherein said storing comprises storing information that enables an identification of a hardware configuration of said network device.

18. The method of claim 15, wherein said storing comprises storing traffic information.

19. The method of claim 15, wherein said storing comprises storing performance information.
